(19) United States
(12) Patent Application Publication
(10) Pub. No.: US 2002/0089568 A1
(43) Pub. Date: Jul. 11, 2002

(54) Recording material and method

(76) Inventors: Jeffrey Ronald King, Cheshire (GB); Simon Richard John Leggett, Marsens (GB); Meinrad Schaer, Ependas (CH)

Correspondence Address: Dara L. Onofrio, Esq., c/o ONOFRIO LAW, Suite 2702, 233 Broadway, New York, NY, 10279, US

(21) Appl. No.: 09/953,640

(22) Filed: Sep. 17, 2001

(30) Foreign Application Priority Data
Sep. 15, 2000 (GB) 0022616.7

(51) Int. Cl. B41J 2/04; B32B 3/00; B32B 5/16; B32B 7/00; B05D 1/32

(52) U.S. Cl. 347/54; 428/202; 428/207; 427/466

(57) ABSTRACT

A recording material comprising a paper substrate coated on at least one surface with at least one pigment layer; and at least one sealing layer which comprises a particulate polymer dispersion having a film forming temperature of between 60° and 160° C. and an average particle size between 1 μm and 50 μm together with at least one water-soluble polymer binder; and a related printing method whereby an image printed on the recording material is heated after printing to seal the sealing layer to provide a protective surface.

### FIELD OF INVENTION

The present invention relates to a recording material and to a method of treatment for images produced therewith. It particularly relates to a recording material for the ink jet process.

### BACKGROUND OF THE INVENTION

The ink jet process is now a widely used printing process since it can be carried out using relatively cheap and simple printers without noise and with high quality, in particular in the case of colour printing. There are several kinds of ink jet printers, for example piezoelectric and thermal drop on demand printers and continuous ink jet printers. In the ink jet process, droplets of a recording fluid, the ink, are applied to the recording material under computer control. With increasing improvement in the availability and mode of operation of ink jet printers there is great interest in using the ink jet process in many imaging and display applications and as an alternative to conventional photographic imaging and printing. Consequently, increasingly severe requirements are being set for the recording materials. The recording produced by means of ink jet processes is required to have, for example, water and smear resistance, high resolution, high colour density, sufficient ink gradation, and good light fastness. There is also interest in providing prints with a glossy or textured image surface. On the other hand there is great interest in achieving high image quality from cheap recording materials rather than by using expensive materials.

However the cheapest recording materials, such as so-called plain paper, generally provide poor images from ink jet printers due to problems such as bleeding, feathering, and cockling. Consequently it has become common to provide recording materials comprising a substrate such as plain paper and at least one ink-receptive recording layer arranged thereon. The recording layer frequently consists of a mixture of a pigment and a binder. In addition to increasing the whiteness and smoothness of the material, the pigment serves to hold the colorants from the ink to prevent problems such as bleeding and feathering. Such materials are adequate for printing text, but still show deficiencies when printing images. For instance cockling can still be a problem due to the greater quantity of ink laid down. To some extent this can be overcome by increasing the coating weight of the pigment layer or by use of additional layers or more complicated formulations, but this then increases the cost of the material. Moreover prints are still susceptible to staining and are poorly robust to handling and scratching, particularly when wet since the binder components in the ink-receptive layer are normally water soluble or water swellable. Furthermore the appearance is unattractive when compared with conventional glossy photographic images.

There is thus a need for an ink jet printing method using a simple and cheap receiving medium but which can provide robust good quality images. There is a particular need for such a method which will additionally provide prints of good gloss.

World Patent Application PCT WO 98/02313 discloses an ink jet recording material comprising a substrate paper which contains synthetic fibres and a porous recording layer which comprises a dispersion of a film forming polymer and a water soluble binder. We have found a suitable medium and method to achieve images of equal quality using pigment coated plain paper as a substrate.

### SUMMARY OF THE INVENTION

It is therefore the object of the present invention to provide a recording material and method which provides water-resistant images of good quality and stability.

The object is achieved by a recording material comprising in order: a sheet-like paper substrate; on which is coated at least one pigment layer; on which is coated at least one sealing layer which comprises a particulate polymer dispersion characterised by a film forming temperature of between 60° and 160° and an average particle size between about 1 μm and about 50 μm together with at least one water-soluble polymer binder.

The recording materials of the invention are particularly suitable for use with the ink jet printing process.

There is also provided a method within the printed image is heated after printing to seal the sealing layer by partly melting and softening the particulate polymer dispersion sufficiently for it to form a film to provide a robust image protecting coating.

The invention will be described in detail in the following description.

### DETAILED DESCRIPTION OF THE INVENTION

The invention provides a recording material comprising a paper substrate coated on at least one surface with at least one pigment layer; and at least one sealing layer which comprises a particulate polymer dispersion having a film forming temperature of between 60° and 160° C. and an average particle size between 1 μm and 50 μm together with at least one water-soluble polymer binder.

The paper substrate to be used in the present invention may be any conventional paper base, for example, paper produced by various apparatus such as a Fourdrinier paper machine, a cylinder paper machine or a twin wire paper machine from a wood pulp including, for example, a chemical pulp, a mechanical pulp, or a waste paper pulp. A suitable paper substrate material is paper having a basis weight of from 50 to 500 gm⁻², preferably from 80 to 250 gm⁻². The paper may be manufactured from a pulp comprising in addition optionally at least one of various conventional additives as are known in the art, for example including a filler or pigment, a binder, a sizing agent, a fixing agent, a yield-improving agent, a cationic agent and a paper strength- increasing agent. The filler content in the paper is preferably not more than 25% by weight, based on dry matter. Suitable fillers include, for example, starch or an inorganic pigment, it being possible to use the same pigments as in the coated pigment layer. The paper may optionally have internal and/or surface sizing with known sizes.

In general the whiteness of the paper should be as high as possible, and it may therefore be advantageous to include in the paper or in the pigment layer components such as optical brightening agents, dyes, or pigments to improve the brightness and whiteness of the paper. However the invention may also be used with coloured or tinted papers. Other additives such as a pigment dispersant, a thickener, a fluidity-improving agent, a defoaming agent, a foam-suppressing agent, a release agent, a blowing agent, a penetrating agent, and ash-preventive agent, a waterproofing agent, a wet strength agent, and a dry strength agent may be incorporated as the case requires. A suitable paper is white bond paper.

The back surface of the paper may be provided with the pigment layer or layers, like the front, or may have a barrier layer against solvents, for example comprising a plastics dispersion, or a coating for lay-flat properties, for example comprising polyvinyl chloride or soluble starch derivatives. Alternatively the back of the paper may be provided with both the pigment layer and the sealing layer like the front. As a further alternative the back surface of the paper may be coated with an adhesive and the adhesive may be protected with a release sheet which is releasably adhered to the adhesive. Thus the image after printing may be caused to adhere to a suitable surface.

Preferably the pigment in the pigment layer is a white pigment. Suitable white pigments include plastic pigments and inorganic pigments such as light calcium carbonate, heavy calcium carbonate, kaolin, talc, calcium sulphate, barium sulphate, titanium dioxide, zinc oxide, zinc sulphide, zinc carbonate, satin white, aluminium silicate, diatomaceous earth, calcium silicate, magnesium silicate, synthetic non-crystalline silica, colloidal silica, colloidal alumina, pseudo boehmite, aluminium hydroxide, alumina, lithopone, hydrolyzed halloysite, montmorillonite, magnesium carbonate, basic magnesium carbonate, magnesium hydroxide, and zeolite and clay-based pigments. It is also possible to use mixtures of these pigments. A combination of 40 to 80 parts of very fine clay with 20 to 60 parts of calcium carbonate is particularly suitable. The pigment layer may also advantageously comprise one or more dispersants and a binder. The coating weight of the pigment layer may be between 10 and 80 gm⁻², preferably between about 15 and about 50 gm⁻².

In addition to the components already mentioned, the pigment layer may contain further auxiliary agents as are known in the art, such as, for example, a wetting agent, a defoaming agent, or a thickening agent. Further there may be more than one pigment layer provided on the surface of the paper, each of which is composed of the pigments and additives mentioned above. Further, a calendering apparatus may be employed to control the flatness of the base paper, or the paper may be supercalendered after coating the pigment layer using high temperature and pressure to produce a gloss paper surface.

The particulate polymer dispersion of the sealing layer may comprise any film-forming thermoplastics dispersion, for example a dispersion of polyurethane, low density polyethylene, high density polyethylene, polypropylene, polyvinyl acetate, polyvinyl acetate copolymers, styrene/butadiene copolymers, styrene/butadiene/acrylonitrile terpolymers, styrene/(meth)acrylate copolymers, (meth)acrylic polymers, ethylene/(meth) acrylic acid copolymers, ethylene/vinyl chloride copolymers, ethylene/(meth) acrylate/maleic terpolymers, and mixtures thereof. A preferable size for the particulate polymer is between about 5 μm and about 20 μm. The particulate polymer should have a melt flow index of at least 5, preferably between about 10 and about 100. A particularly suitable particulate polymer comprises low density polyethylene microspheres having an average diameter of about 12 μm and a melt flow index of 75. Another particularly suitable particulate polymer comprises microspheres of a 7% acrylic acid/ polyethylene copolymer having an average diameter of about 10 μm and a melt flow index of 9. Another suitable particulate polymer comprises low density polyethylene particles of random shape and a particle size of about 13 μm and a melt flow index of 70. These polymers have melting points of 105-107° C.

The polymer of the film forming dispersion may optionally contain other additives such as, for example, UV absorbers, light stabilisers such as hindered amines, optical brightening agents, or tinting agents.

The other component of the sealing layer is a film-forming water soluble binder. All water-soluble polymers whose use as binders in recording layers is known may in principle be used, and suitable examples include poly (vinyl alcohol), copolymers of poly (vinyl alcohol), carbohydrates such as tragacanth gum, or water-soluble starch derivatives, water-soluble cellulose derivatives such as hydroxyethyl cellulose or carboxymethyl cellulose, water-soluble methacrylates containing hydroxyl groups and copolymers thereof, poly (vinyl pyrrolidone), gelatin, casein, and mixtures of such binders. A particularly suitable hydrophilic binder is poly (vinyl alcohol) which is hereinafter referred to as PVOH. A preferred binder is PVOH which has a degree of hydrolysis of at least 85%, and a particularly preferred binder is PVOH which has a degree of hydrolysis of between about 98% and about 99%.

The coating weight of the sealing layer may be between about 3 and about 50 gm⁻². A preferred coating weight is between about 8 and about 30 gm⁻². Depending on the use of the recording material, the ratio of the particulate polymer dispersion to the water soluble binder in the porous recording layer may be varied in the range from about 10:1 to about 1:1, with a ratio of approximately 5:1 being preferred. This ratio and the overall coating weight can be used to adjust the ease of coating, the image quality of the final print, and resistance to scratching, abrasion, and water.

In addition to the components already mentioned, the sealing layer may contain further auxiliary agents as are known in the art, such as, for example, surfactants, cross linking agents, dye fixing agents, fungicides, inorganic pigments, lubricants, dispersants, antifoams, ultraviolet absorbers, and optical brighteners. Suitable crosslinking agents are, for example, aldehydes such as glyoxal, polyisocyanates, polyepoxides and polyaziridines. Suitable dye fixing agents known in the art include cationic or basic compounds such as quaternary ammonium and phosphonium polymers and polymers comprising basic monomers such as vinyl pyridine, vinyl imidazole, amine containing (meth)acrylates, copolymers of such monomers with other ethylenically unsaturated monomers, and quaternised reaction products from such polymers.

Optionally there may also be present additional layers in the assembly. Specifically there may be present between the pigment layer and the sealing layer a dye trapping layer comprising a dye fixing compound in a suitable binder. Suitable dye fixing compounds include basic or cationic polymers and inorganic species such as salts comprising polyvalent metallic ions, silica or alumina, particularly cationically modified silica or alumina. Suitable cationic polymers known in the art as dye fixing compounds include quaternary ammonium and phosphonium polymers and polymers comprising basic monomers such as vinyl pyridine, vinyl imidazole, amine containing (meth)acrylates, copolymers of such monomers with other ethylenically unsaturated monomers, and quatemised reaction products from such polymers. Suitable binders for the dye trapping layer include any of the water-soluble polymers whose use as binders in recording layers is known, such as poly (vinyl alcohol), copolymers of poly (vinyl alcohol), carbohydrates such as tragacanth gum, or water-soluble starch derivatives, water-soluble cellulose derivatives such as hydroxyethyl cellulose or carboxymethyl cellulose, water-soluble methacrylates containing hydroxyl groups and copolymers thereof, poly (vinyl pyrrolidone), gelatin, casein and mixtures of such binders.

The recording materials of the invention are particularly suitable for use with the ink jet printing process. Any convenient ink jet printer may be used for printing on the materials of the invention, for example a continuous printer or a piezoelectric or thermal drop-on-demand printer. Suitable jetting inks include aqueous inks and those based on organic solvents such as 2-butanone (MEK), ester solvents, and mineral oils. Suitable colorants for these inks include dyes or pigments. Preferred inks for the invention are aqueous inks.

The recording materials of the invention may also be used with other printing methods as are known in the art, such as, for example flexographic and gravure printing, or as writing or drawing materials for use with felt tipped pens and the like.

The recording materials of the invention are particularly suitable for use in a printing process wherein the printed image is heated after printing to seal the porous recording layer by partly melting and softening the particulate polymer dispersion sufficiently for it to form a film to provide a robust image protecting coating.

Therefore according to this aspect of this invention, the printed image is heated after printing to seal the sealing layer. The heating process may use any convenient method, such as heated air, contact with a heated surface, or infra red or microwave radiation. Alternatively the print may be heated under pressure in contact with a heated surface or by passing it between heated rollers. The recording layer may be heated at temperatures between about 80° C. and about 180° C., preferably between about 100° C. and about 120° C.

It is important that the components of the substrate and pigment layer are not affected by this heating process. One of the advantages of the preferred particulate polymers of the porous recording layer of the invention is that the softening points are relatively low and thus the temperature and time needed to seal them are minimised.

According to another aspect of the invention, the printed image is heated under pressure with the image surface in contact with a second, inert sheet which is held against the image protective layer of the material. The inert sheet does not adhere to the material, but protects it from the rollers used to apply the pressure. Suitable inert sheets include polyester films, polyamide films, and casting papers. The inert sheet may be treated with silicones or ptfe to enhance the release properties. Furthermore a suitable choice of the inert sheet may be used to produce a desired appearance to the final image such as the use of a smooth inert sheet which will impart a high gloss to the image or a textured sheet which will produce a textured finish.

Preferably according to this aspect of this invention, the printed image is heated by passing through a laminator. By laminator is meant a device which is normally used for the lamination of printed images which comprises a means of heating and pressing together the image and the cover sheet, commonly by passing them through a nip between a pair of heated rollers.

It is found that, unexpectedly, images produced on the materials of the invention become significantly brighter and denser in appearance after the image has been heated and sealed. Hitherto it has been difficult to achieve adequate brightness and density of ink jet prints to compete with photographic printing quality without so increasing the ink load that the resulting prints are slow to dry and show defects such as puddling, coalescence, and incomplete absorption of the ink. We have found that the porosity of the sealing layer in the inventive materials can itself contribute to ink absorption and thus reduce the tendency to puddling and coalescence when printing. This is particularly apparent when the layer is coated on a material which has poor image receiving properties. This additional functionality is not the prime purpose of the sealing layer but can represent a significant advantage. Depending on the rest of the assembly, and on the type of ink used, the colorant can reside in the sealing layer or in an underlayer, or be distributed between the layers. The presence of colorant in the sealing layer does not impair effective sealing or the quality of the image.

Many types of pigment coated paper are readily available and in wide commercial use. One of the advantages of the present invention is that the sealing layer may be produced as an aqueous formulation and coated on to a commercially available pigment coated paper, and that after printing and heat treatment a final high quality image is easily and cheaply produced. Any convenient coating method may be used for the preparation of the materials of the present invention, such as blade coating, knife coating, and slide coating.

The materials and method of the invention are particularly useful in so called photofinishing applications used for providing the output from imaging devices. After printing and sealing the final image has a pleasing appearance and feel, and may be provided with a glossy or other desired texture and used as an alternative to conventional photographic prints.

The materials and method of the invention are also particularly suitable for use as labels or tags. In one aspect of the invention for use as labels or tags the back surface of the paper is provided with a pigment coating and with a sealing layer like the front. Such a material may be printed on both sides and subsequently sealed on both sides to provide a robust label or tag.

According to another aspect of the invention for use as labels the back surface of the paper may be coated with an adhesive and subsequently the adhesive may be used to cause the printed and sealed image to adhere to a suitable substrate. Preferably according to this aspect of the invention the adhesive may be protected with a release sheet. Optionally the adhesive and release sheet may be applied before some or all of the face side coatings. The release sheet is releasably adhered to the rest of the material, and is selected on such a basis that the release sheet has an adhesive force sufficiently strong not to be peeled during transportation in an ink jet recording apparatus or during heating but weak enough to peel easily when it is desired to attach the printed image to a suitable surface. Alternatively the adhesive may be applied after the face side coatings or after printing and sealing.

Suitable adhesives include solvent type and aqueous type adhesives. Suitable aqueous adhesives are well known and include soluble adhesives such as poly vinyl alcohol and polyvinyl pyrrolidone and emulsion type adhesives obtained by emulsion polymerisation in water of vinylically unsaturated monomers employing a surface active agent. Preferably the adhesive is a pressure sensitive organic solvent type adhesive such as a rubber type adhesive or an acrylic resin type adhesive. The main material of the rubber-type adhesive is natural rubber or styrene-butadiene rubber. To the natural rubber, a resin or a plasticiser may be incorporated, and a suitable solvent for coating such as n-hexane. The acrylic resin type adhesive may be prepared by polymerising an acrylic monomer such as 2-ethylhexyl acrylate, butyl acrylate, ethyl acrylate, or β-hydroxyethyl acrylate in an organic solvent. Further, in order to improve the physical properties such as the heat resistance and the solvent resistance of the adhesive, the above material may be cross linked using a cross linking agent such as an isocyanate, or a pigment such as silica, kaolin, clay, calcium carbonate, aluminium hydroxide, zinc oxide, titanium dioxide, melamine resin particles or starch particles, may be incorporated to the above material. Depending upon the particular purpose for which the recording material is employed other additives may be incorporated in the adhesive layer including a water soluble polymer, a petroleum type resin, a paraffin wax, a fatty acid or its derivative, a higher alcohol, a metal soap, or a silicone as well as an antistatic agent, a thickener, a dispersant, a preservative, an antioxidant or a defoaming agent.

Suitable materials for a release sheet include wood free paper, kraft paper, glassine paper, impregnated paper, or a plastic film such as a polyester film or a polyamide film which may be coated with a silicone resin or ptfe as a release agent.

The following examples will serve to illustrate the invention. These examples are merely representative and are not inclusive of all the possible embodiments of the invention.

### EXAMPLE 1

A receiving sheet according to the invention was prepared as follows. A formulation was prepared using the following components listed in Table 1 below.

TABLE 1

| | | |
|---|---|---|
| 98% PVOH 7.5% | 40.0 | g |
| solution | | |
| Surfactant 3% solution | 20.0 | g |
| Polyethylene particles | 20.0 | g |
| Deionised water | 20.0 | g |

The surfactant used was a non-ionic wetting agent based on octylphenol ethoxylate (average 9 to 10 moles ethylene oxide) available under the trade name Triton X100 from Union Carbide Chemicals and Plastics Company Inc., Danbury, Conn., U.S.A. The polymer particles comprised low density polyethylene particles of random shape with an average particle size of about 13 μm and a melt flow index of 70 available under the trade name Coathylene HX1681 from duPont Polymers.

This formulation was coated with a wet coat weight of 36 gm⁻² onto a commercially available supercalendered glossy printing paper consisting of a kraft paper of substance 130 gm⁻² with a two layer pigment coating having a total coating weight of approximately 22 gm⁻² on each side of the sheet. The first coat comprised a calcium carbonate pigment in a styrene-butadiene copolymer binder and the second coat comprised a mixture of calcium carbonate, English kaolin clay and plastic pigments in the approximate proportions 60 parts:35 parts:5 parts together with a styrene-acryliccopolymer binder.

A test pattern was printed with aqueous dye-based inks using an Epson 800 printer, allowed to dry, and the coating was sealed by passing it through a Seal Image 400 laminator at a heat setting corresponding to a temperature of 118° C. with the image face contacted with a smooth sheet of polyester film. A clear glossy high quality image was produced which was resistant to the ingress of water and to rubbing when wet.

The print prepared according to the invention was compared with an identical image printed on the supercalendered glossy printing paper without the overcoat. This was found to be of very poor quality due to the inability of the paper to absorb the ink and was further degraded when contacted with water. This shows the advantage of the inventive assembly and method in providing dense images of excellent quality.

### EXAMPLE 2

A receiving sheet according to the invention was prepared as follows:-

A formulation prepared as in Example 1 was coated with a wet coat weight of 36 gm⁻² on to a commercially available ink jet receiving medium consisting of a 160 gm⁻² kraft paper coated with a layer of pigments and a cationic polymer, the latter acting as a mordant for types of dye used in water soluble ink jet inks. A test pattern was printed with aqueous dye-based inks using an Epson 800 printer, allowed to dry, and the coating was sealed by passing it through a Seal Image 400 laminator at a heat setting corresponding to a temperature of 118° C. with the image face contacted with a smooth sheet of polyester film. A clear glossy high quality image was produced which was resistant to the ingress of water and to rubbing when wet.

The image prepared according to the invention was compared with the same test pattern printed on the ink jet receiving medium without the topcoat. This was of similar image quality but remained matt in surface and the medium was subject to cockling and staining when contacted with water. This shows the advantage of the invention in providing robust glossy images.

### EXAMPLE 3

A formulation was prepared using the following components listed in Table 2 below.

TABLE 2

| | | |
|---|---|---|
| Deionised water | 34.8 | g |
| Silicone surfactant | 0.2 | g |
| 99% PVOH 10% | 40.0 | g |
| solution | | |
| Polyethylene particles | 25.0 | g |

The PVOH was a commercial sample from Harco available under the trade name Mowiol 28-99. The silicone surfactant was a commercial sample from Byk chemie under the trade name Byk 348. The polyethylene particles were the same as in example 1.

This formulation was prepared by slowly adding the PVOH to the surfactant and water and mixing well, and then adding the polymer beads with good stirring. The final formulation was mixed at high speed for 20 minutes and then left in an ultrasonic bath for 15 minutes. It was coated on to a commercially available silica coated plain paper having a total weight of 100 gm⁻² to give a coating weight of the porous recording layer of approximately 20 gm⁻². An image was printed using aqueous inks on an Epson Stylus Color 3000 printer, allowed to dry, and the coating was sealed by passing it through a GBC 1200 laminator at a heat setting corresponding to a temperature of 120° C. with the image face contacted with a piece of smooth casting paper as an inert sheet. A clear bright glossy image was produced which was resistant to water and rubbing.

### EXAMPLE 4

Three materials were prepared and tested for a label application as follows:

A. A commercially available pigment coated label paper of substance 83 gm⁻² and thickness 65 microns.

B. The same label paper overcoated with the same polyethylene bead dispersion as in Example 1 at the same coating weight.

C. The same label paper on which was coated sequentially:

(a) a dye trapping layer consisting of an equal mixture of methylhydroxypropyl cellulose and gelatin at a total dry coat weight of 3 gm⁻² with a surfactant as coating aid which was allowed to dry before further overcoating with the same polyethylene bead dispersion as in Example 1 at the same coating weight as in Example 1.

The three samples were printed with a test pattern using an Epson 1270 ink jet printer. Sample A did not give a satisfactory print due to inadequate absorption of the ink which caused it to puddle and run on the surface. Furthermore the inks were not resistant to rubbing when wet. No more work was done on this sample.

Samples B and C were treated, after printing and drying, to seal the polyethylene bead layer by passing them through a GBC 3500 laminator at a heat setting of 113° C. with the image face contacted with a smooth sheet of polyester film. Sample B gave an image of acceptable quality though there was some evidence of uneven print density due to coalescence of the ink on the surface and also some sideways diffusion of the ink leading to reduced sharpness of the image. Sample C had excellent image quality with even density and good sharpness. This shows the advantage of a dye trapping layer under the sealing layer.

The printed and sealed samples B and C were cut to a size of approximately 8 cm by 10 cm and adhered to a clean glass bottle with a solvent based adhesive. Both labels were resistant to immersion in cold water for at least five minutes and to rubbing when wet.

### EXAMPLE 5

A commercially available self adhesive label paper comprising a pigment coated paper base backed with adhesive and a release liner was overcoated on the face side with the polyethylene bead dispersion prepared according to Example 1 at the same coating weight. After drying it was printed, sealed as in Example 1 and applied to a glass bottle after removing the release liner. The image produced was clear, glossy and of good quality and the label when attached to the bottle was resistant to immersion in cold water for at least five minutes and to rubbing when wet.

The foregoing description of various and preferred embodiments of the present invention has been provided for purposes of illustration only, and it is understood that numerous modifications, variations and alterations may be made without departing from the scope and spirit of the invention as defined in the claims appended hereto.

1. A recording material comprising:
a paper substrate coated on at least one surface with
at least one pigment layer; and
at least one sealing layer which comprises a particulate polymer dispersion having a film forming temperature of between 60° and 160° C. and an average particle size between 1 μm and 50 μm together with at least one water-soluble polymer binder.

2. The recording material according to claim 1, wherein said pigment layer is coated on said surface of the substrate and said sealing layer is coated on said pigment layer.

3. The recording material according to claim 1, wherein said pigment layer includes at least one white pigment.

4. The recording material according to claim 1, wherein said pigment layer includes one or more pigment selected from the group consisting of calcium carbonate, kaolin, talc, calcium sulphate, barium sulphate, titanium dioxide, zinc oxide, zinc sulphide, zinc carbonate, satin white, aluminium silicate, diatomaceous earth, calcium silicate, magnesium silicate, magnesium carbonate, synthetic non-crystalline silica, colloidal silica, colloidal alumina, pseudo boehmite, aluminium hydroxide, alumina, lithopone, hydrolyzed halloysite, montmorillonite, magnesium hydroxide, zeolite and clay-based pigments.

5. The recording material according to claim 1, wherein the coating weight of said pigment layer is between 10 and 80 gm⁻².

6. The recording material according to claim 1, wherein said particulate polymer dispersion comprises at least one polymer selected from the group consisting of 30 polyurethane, low density polyethylene, high density polyethylene, polypropylene, polyvinyl acetate, polyvinyl acetate copolymers, styrene/butadiene copolymers, styrene/butadiene/acrylonitrile terpolymers, styrene/(meth)acrylate copolymers, (meth)acrylic polymers, ethylene/(meth)acrylic acid copolymers and ethylene/vinyl chloride copolymers.

7. The recording material according to claim 1, wherein said particulate polymer dispersion comprises low density polyethylene.

8. The recording material according to claim 1, wherein said water soluble binder is selected from the group consisting of polyvinyl alcohol, copolymers of poly vinyl alcohol, tragacanth gum, casein, water-soluble starch, hydroxyethyl cellulose, carboxymethyl cellulose, polyvinyl pyrrolidone, gelatin, and water-soluble (meth)acrylate polymers.

9. The recording material according to claim 1, wherein said water soluble binder is polyvinyl alcohol having a degree of hydrolysis of at least 85%.

10. The recording material according to claim 1, which further comprises a dye trapping layer.

11. The recording material according to claim 10, wherein said dye trapping layer is between said pigment layer and said sealing layer.

12. The recording material according to claim 10, wherein said dye trapping layer comprises at least one dye fixing compound and a binder.

13. The recording material according to claim 1, wherein the uncoated substrate surface is coated with an additional pigment layer.

14. The recording material according to claim 13, wherein said additional pigment layer is coated with an additional sealing layer.

15. The recording material according to claim 1, wherein the uncoated substrate surface is coated with an adhesive.

16. The recording material according to claim 15, wherein said adhesive is protected with a release sheet.

17. A printing method whereby an image printed on a recording material comprising a substrate coated on at least one surface with a pigment layer and a sealing layer, wherein said sealing layer comprises a particulate polymer dispersion having a film forming temperature of between 60° and 160° C. and an average particle size between 1 μm and 50 μm together with at least one water-soluble polymer binder; is heated after printing to seal said sealing layer to provide a protective surface.

18. The printing method according to claim 17, whereby the recording material is printed using the ink jet printing process.

19. The printing method according to claim 17, whereby the printed material is heated under pressure with the image surface in contact with a second, inert sheet which is held against the image protective layer of the material.

20. The printing method according to claim 19, whereby the printed material and inert sheet are heated under pressure by passing them through a laminator.

21. The printing method according to claim 17, whereby the material is printed using a flexographic printing process.
